(19) United States
(12) Patent Application Publication
(10) Pub. No.: US 2007/0232742 A1
(43) Pub. Date: Oct. 4, 2007

(54) LAYERED SILICATE COMPOUND AND RESIN COMPOSITION CONTAINING THE LAYERED SILICATE COMPOUND

(75) Inventor: HIROSHI MAEHARA, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/676,815

(22) Filed: Feb. 20, 2007

(30) Foreign Application Priority Data
Mar. 31, 2006 (JP) 2006-098676

(51) Int. Cl. C08K 9/04

(52) U.S. Cl. 524/445; 556/173

(57) ABSTRACT

Provided are a layered silicate compound capable of developing high flame retardancy in a small mixing amount, and a resin composition containing the layered silicate compound. The layered silicate compound is obtained by being organophilized with an organophilizing agent having a flame retardant skeleton.

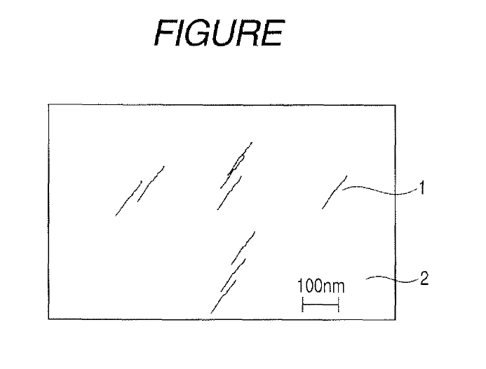

### BACKGROUND OF THE INVENTION

1. Field of the Invention

The present invention relates to a layered silicate compound capable of developing high flame retardancy even in a small mixing amount, and to a resin composition containing the layered silicate compound.

2. Description of the Related Art

Plastics to be used for specific electrical devices require flame retardancy. Meanwhile, most organic polymer compounds do not satisfy the required flame retardancy, so the compounds are used with a flame retardant added thereto for satisfying the requirement. In particular, a flame retardant is required to be mixed into a resin composition in a high mixing ratio for attaining high flame retardancy, but mixing of a large amount of the flame retardant inevitably degrades inherent physical properties of the resin. Further, some flame retardants may provide environmental load. Thus, a resin composition having high flame retardancy in as small a mixing amount of retardants as possible is desired.

One reason for mixing of the flame retardant in a high mixing ratio relates to a dispersion state of the flame retardant in the resin. In a flame retardant resin composition which appears to be uniformly mixed macroscopically, the flame retardant is microscopically aggregated and nonuniformly distributed in the resin. Thus, for suppressing combustion of the resin, an excess amount of the flame retardant needs to be mixed into the resin, resulting in degrading resin properties. This nonuniform distribution phenomenon cannot be suppressed with any arranged kneading processes for mixing of the flame retardant.

Japanese Patent Application Laid-Open No. 2004-292689 discloses that a so-called nano-composite material containing a layered silicate dispersed in a resin in nano-order improves flame retardancy.

However, use of the nano-composite material described in Japanese Patent Application Laid-Open No. 2004-292689 as a molding component requires higher flame retardancy.

### SUMMARY OF THE INVENTION

The present invention provides a layered silicate compound capable of developing high flame retardancy in a small mixing amount, and a resin composition containing the layered silicate compound.

The present invention provides a layered silicate compound, which is organophilized with an organophilizing agent having a flame retardant skeleton.

Further, the present invention provides a resin composition including a resin and the layered silicate compound.

Still further, the present invention provides a method of producing a resin composition including: kneading a resin having a furan ring in its molecule and a layered silicate compound organophilized with an organophilizing agent having a flame retardant skeleton; and dispersing the layered silicate compound in the resin.

Yet further, the present invention provides a molded product, which is obtained by molding the resin composition.

According to the present invention, a layered silicate compound capable of developing high flame retardancy in a small mixing amount, and a resin composition containing the layered silicate compound can be provided. The resin composition of the present invention has favorable physical properties such as mechanical strength and heat resistance, and is effective for recycling.

Further features of the present invention will become apparent from the following description of exemplary embodiments with reference to the attached drawings.

### BRIEF DESCRIPTION OF THE DRAWING

FIGURE is a schematic diagram of transmission electron microscope observation results.

### DESCRIPTION OF THE EMBODIMENTS

The present invention utilizes nano-dispersibility of a layered silicate compound. That is, the present invention utilizes a phenomenon in which a layered silicate compound subjected to organophilization treatment is getting microscopically dispersed during kneading with a resin while being exfoliated by shearing stress.

A resin composition containing a layered silicate microscopically dispersed in a resin is known as a so-called polymer nano-composite. For example, the polymer nano-composite can be obtained by adding a small amount of an organophilic layered silicate compound to a resin and kneading the mixture under high shearing stress. An example of the organophilic silicate compound is a compound prepared by substituting a sodium ion, which is an interlayer substance of a layered silicate montmorillonite being a layered silicate, with a quaternary ammonium compound having a long-chain alkyl group. In this method, the organophilic layered silicate compound having a multilayer structure exfoliates at each interlayer, and a layered silicate having a single- or multi-layer structure can be dispersed in a resin in nano-order scale. Further, the thus-obtained polymer nano-composite is known to have significantly improved rigidity and heat resistance compared with those of a resin before mixing.

The inventor of the present invention have conceived that use of an organophilizing agent having a flame retardant skeleton bonded thereto allows dispersion of the organophilizing agent having a flame retardant skeleton bonded thereto in a resin in nano-order scale by utilizing such properties of nano-dispersion. That is, the layered silicate compound of the present invention is obtained by organophilizing a layered silicate with an organophilizing agent having a flame retardant skeleton. In this way, dispersion of an organophilizing agent having a flame retardant skeleton in a resin in nano-order is realized by allowing the layered silicate to carry an organophilizing agent having a flame retardant skeleton and utilizing dispersibility of the layered silicate in nano-order scale. As a result, the addition amount of a flame retardant to the resin can be significantly reduced, and environmental responsiveness of the resin improves. Further, degradation in physical properties associated with an addition of a large amount of the flame retardant can be reduced, and recycling efficiency of the resin improves.

The term “layered silicate” means a layered silicate mineral having an exchangeable metal cation such as a sodium ion, which is present in an interlayer of the layered silicate. A silicate mineral may be a natural product or a synthetic product. Examples of the layered silicate to be used include general nanocomposite materials such as: smectites such as montmorillonite, saponite, hectorite, beidellite, stevensite, and nontronite; swellable synthetic mica; imogolite; vermiculite; and halloysite. Of those, montmorillonite and synthetic mica are favorable. Those layered silicates may each be used alone, or two or more kinds of them may be used in combination.

As the layered silicate, a layered silicate having an ion exchange capacity of about 60 to 150 meq/100 g can favorably be used.

As the organophilizing agent used for organophilization of the layered silicate, a quaternary ammonium compound having a flame retardant skeleton or a quaternary phosphonium compound having a flame retardant skeleton is favorably used. The flame retardant skeleton is favorably a skeleton derived from a flame retardant having reactivity. Such a flame retardant having reactivity can react with an amine compound, a phosphine compound, or the like, to thereby easily obtain an organophilizing agent having a flame retardant skeleton. A favorable example of the flame retardant having reactivity is a phosphate-based flame retardant such as 9,10-dihydro-9-oxa-10-phosphaphenanthrene-10-oxide represented by the formula (1). A reaction of the phosphate-based flame retardant represented by the formula (1) with trimethylamine represented by the formula (6) provides a quaternary ammonium compound having a flame retardant skeleton represented by the formula (7).

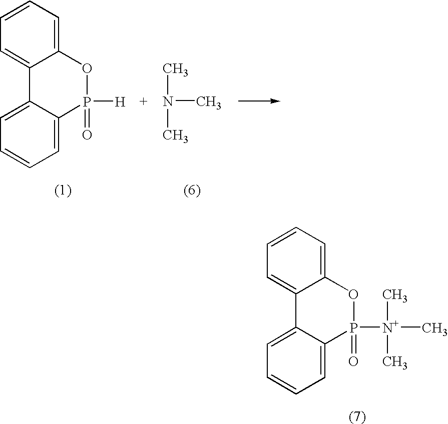

Examples of the flame retardant include flame retardants having the following structures and available from SANKO Co., Ltd (each name is a trade name). Those flame retardants may be used alone, or in combination of two or more kinds thereof.

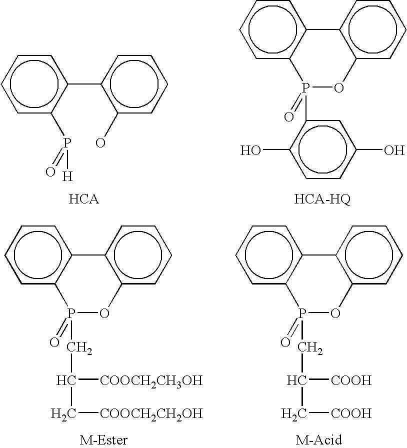

Examples of the amine compound include trimethylamine, triethylamine, triisopropylamine, and diethylisopropylamine. Of those, trimethylamine is favorable. Those amine compounds may used alone, or in combination of two or more kinds thereof.

Examples of the phosphine compound include trimethylphosphine, dibutyldodecylphosphine, and dibutylhexadecylphosphine. Of those, trimethylphosphine and dibutyldodecylphosphine are favorable. Those phosphine compounds may be used alone, or in combination of two or more kinds thereof.

The reaction of the flame retardant having reactivity with an amino compound, a phosphine compound, or the like may be conducted through another compound. For example, an acid chloride compound such as decyl (meth)acrylic acid chloride is used, thereby being capable of easily obtaining an organophilizing agent having a flame retardant skeleton.

Description will now be given of an example of an organophilization reaction of a layered silicate. First, a layered silicate is swelled and dispersed in warm water (30 to 90° C., for example). Then, an organophilizing agent having a flame retardant skeleton is gradually added thereto, and the mixture is left standing for 20 to 30 hours. The obtained suspension is filtrated, and the thus obtained solid is repeatedly washed with warm water or the like to remove remaining exchangeable metal cations such as sodium ions and the organophilizing agent. Finally, the resultant is dried in an oven, to thereby obtain a powdery layered silicate compound.

The amount of the organophilizing agent to be used in the organophilization reaction is favorably such an amount as to allow substitution of the exchangeable metal cations such as sodium ions present in an interlayer of the layered silicate. In general, the organophilizing agent is used in an amount of about 5 to 200 milli-parts by mass with respect to 100 parts by mass of the layered silicate.

Such a layered silicate compound can be added to a resin to form a resin composition. In this way, the layered silicate compound can be dispersed in the resin composition in nano-scale, and high flame retardancy can be imparted. With this method, a flame retardant originally having undesirable compatibility with a resin can be dispersed more uniformly in the layered silicate compound organophilized with an organophilizing agent having a skeleton of the flame retardant.

The resin to be used is not particularly limited, and a general resin may be used. Examples of the resin to be used include: a polyester-based resin such as polyethylene terephthalate, polypropylene terephthalate, polybutylene terephthalate, polybutylene furan dicarboxylate, polylactic acid, or polycaproic acid; polycarbonate; a polyamide-based resin such as polyamide 6 or polyamide 66; a polyolefin-based resin such as polyethylene, polypropylene, polystyrene, or polyvinyl chloride; an acrylic resin such as polymethyl (meth)acrylate, polyethyl(meth)acrylate, or polyhydroxyethyl(meth)acrylate; a water-soluble resin such as polyvinyl alcohol, polyhydroxypropyl cellulose, or polyhydroxyethyl cellulose; an elastomer such as polybutadiene, polyisoprene, or polyneoprene; and a polymer alloy of an ABS resin or the like and the resins described above. Of those, from a viewpoint of providing a significant effect obtainable by dispersing a layered silicate compound, a resin having a furan ring in its molecule is favorable, and polyalkylene furan dicarboxylate such as polybutylene furan dicarboxylate is more favorable. The number of carbon atoms in the alkylene part of polyalkylene furan dicarboxylate is favorably 2 to 4. One kind of resin may be used alone, or two or more kinds thereof may be used in combination.

The content of the layered silicate compound to be contained in the resin composition is favorably 1 to 50 mass %. A content thereof of 1 mass % or more can impart higher flame retardancy. A content thereof of 50 mass % or less provides a significant effect of suppressing degradation in physical properties such as mechanical strength and heat resistance of the resin. The content thereof is more favorably 2 to 10 mass %, and most favorably 2 to 5 mass %.

Description will now be given of an example of a method of preparing a resin composition containing a layered silicate compound dispersed in a resin with a twin-screw kneader. First, a resin is charged into a twin-screw kneader temperature-controlled to the melting point of the resin or higher. Then, a layered silicate compound is added by using a metering feeder while conducting kneading. The layered silicate compound is gradually exfoliated and dispersed in the resin by shearing stress caused by the screw in the kneader. At this time, an organophilizing agent having a flame retardant skeleton bonded to the layered silicate compound is dispersed together with the layered silicate compound, and thus the organophilizing agent having a flame retardant skeleton is eventually dispersed in the resin in nano-order scale. The kneaded resin composition may be pelletized with a pelletizer thereafter.

Pellets are sliced into thin slices by using a microtome, and the dispersion state of the layered silicate compound can be observed with a transmission electron microscope. As schematically shown in FIGURE, it can be observed that layered thin slices 1 of the layer-exfoliated layered silicate compound are dispersed in a resin phase 2 in nano-order scale.

The thus-obtained pellets are molded by using an injection molding machine. A flame retardancy test is conducted in accordance with the UL 94 standard for confirming the flame retardancy. The resin composition of the present invention is capable of developing flame retardancy of V0 or 5V. In the case where the flame retardancy is required to be further improved, a drip-preventer such as polytetrafluoroethylene or the like may further be added to the resin composition of the present invention.

### EXAMPLES

### Synthesis Example 1

A phosphate-based flame retardant (9,10-dihydro-9-oxa-10-phosphaphenanthrene-10-oxide) represented by the formula (1) and decyl acrylic acid chloride represented by the formula (2) were subjected to a condensation reaction, to thereby obtain a compound represented by the formula (3). Note that as the phosphate-based flame retardant represented by the formula (1), HCA (trade name) available from SANKO Co., Ltd. was used. Then, trimethylamine was reacted with the compound represented by the formula (3), to thereby obtain a quaternary ammonium compound having a flame retardant skeleton represented by the formula (4).

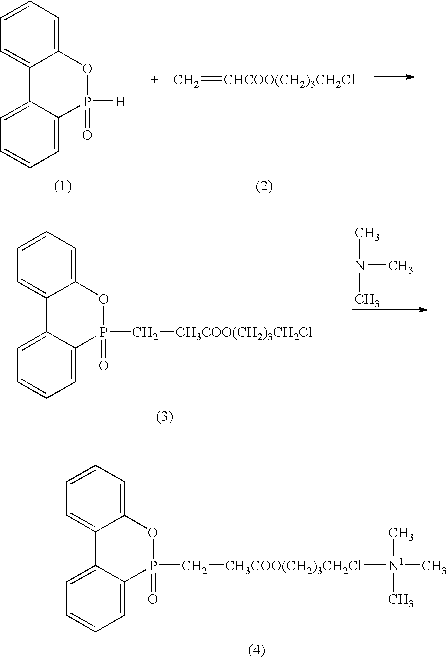

### Synthesis Example 2

A quaternary phosphonium compound having a flame retardant skeleton represented by the formula (5) was obtained in the same manner as in Synthesis Example 1 except that trimethylphosphine was used instead of trimethylamine.

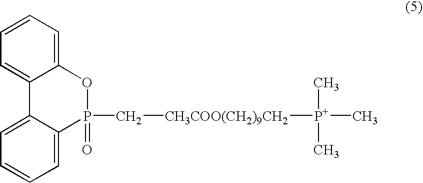

### Example 1

1 part by mass of montmorillonite (available from KUNIMINE INDUSTRIES Co., Ltd., trade name: Kunipia F, ion exchange capacity: 109 meg/100 g) as a layered silicate clay mineral was swelled and dispersed in 100 parts by mass of warm water at 60° C. under stirring. Then, 47 milli-parts by mass of the quaternary ammonium compound represented by the formula (4) obtained in Synthesis Example 1 was gradually added thereto, and the mixture was left standing for 24 hours, to thereby substitute sodium ions in the montmorillonite with quaternary ammonium ions of the quaternary ammonium compound. The precipitate was separated through filtration, repeatedly washed with ultrapure water to remove the sodium ions, and dried, to thereby obtain organophilic montmorillonite powder.

### Example 2

Organophilic montmorillonite powder was obtained in the same manner as in Example 1 except that the quaternary phosphonium compound represented by the formula (5) obtained in Synthesis Example 2 was used instead of the quaternary ammonium compound represented by the formula (4) obtained in Synthesis Example 1.

### Example 3

The organophilic montmorillonite powder obtained in Example 1 was added to polybutylene furan dicarboxylate to obtain a concentration of 3 mass % and kneaded by using a twin-screw kneader, to thereby obtain a pelletized resin composition. Note that as the twin-screw kneader, HK-25D (41D) (trade name) manufactured by Parker Corporation Inc. was used. Kneading conditions included: a temperature of 190° C.; co-rotating twin-screw; a rotation frequency of 500 rpm; and a kneading time of 1 minute.

X-ray diffraction measurement of the obtained resin composition confirmed that the diffraction peak derived from the montmorillonite multilayer structure of the organophilic montmorillonite disappeared. Further, transmission electron microscope observation confirmed that the organophilic montmorillonite was dispersed in the resin in a layer-exfoliated state.

### Example 4

A pelletized resin composition was obtained in the same manner as in Example 3 except that the organophilic montmorillonite powder obtained in Example 2 was used instead of the organophilic montmorillonite powder obtained in Example 1.

X-ray diffraction measurement of the obtained resin composition confirmed that the diffraction peak derived from the montmorillonite multilayer structure of the organophilic montmorillonite disappeared. Further, transmission electron microscope observation confirmed that the organophilic montmorillonite was dispersed in the resin in a layer-exfoliated state.

### Example 5

A pelletized resin composition was obtained in the same manner as in Example 3 except that kneading was conducted at 250° C.

X-ray diffraction measurement of the obtained resin composition confirmed that the diffraction peak derived from the montmorillonite multilayer structure of the organophilic montmorillonite disappeared. Further, transmission electron microscope observation confirmed that the organophilic montmorillonite was dispersed in the resin in a layer-exfoliated state.

### Example 6

A pelletized resin composition was obtained in the same manner as in Example 4 except that kneading was conducted at 250° C.

X-ray diffraction measurement of the obtained resin composition confirmed that the diffraction peak derived from the montmorillonite multilayer structure of the organophilic montmorillonite disappeared. Further, transmission electron microscope observation confirmed that the organophilic montmorillonite was dispersed in the resin in a layer-exfoliated state.

### Comparative Example 1

A pelletized resin composition was obtained in the same manner as in Example 3 except that commercially available organophilic montmorillonite powder and the phosphate-based flame retardant represented by the formula (1) were each used in a concentration of 3 mass % instead of the organophilic montmorillonite powder obtained in Example 1. Note that as the commercially available organophilic montmorillonite, Kunipia T (trade name) available from KUNIMINE INDUSTRIES Co., Ltd., which is organophilic montmorillonite powder prepared by using trimethylstearyl ammonium as an organophilizing agent, was used.

X-ray diffraction measurement of the obtained resin composition confirmed that the diffraction peak derived from the montmorillonite multilayer structure of the organophilic montmorillonite disappeared. Further, transmission electron microscope observation confirmed that the organophilic montmorillonite was dispersed in the resin in a layer-exfoliated state.

### Comparative Example 2

A pelletized resin composition was obtained in the same manner as in Comparative Example 1 except that kneading was conducted at 250° C.

X-ray diffraction measurement of the obtained resin composition confirmed that the diffraction peak derived from the montmorillonite multilayer structure of the organophilic montmorillonite disappeared. Further, transmission electron microscope observation confirmed that the organophilic montmorillonite was dispersed in the resin in a layer-exfoliated state.

[Flame Retardancy Test]

The resin compositions obtained in Examples 3 to 6 and Comparative Examples 1 and 2 were subjected to injection molding under appropriate temperature conditions by using a mold for physical property evaluation, to thereby prepare a flame retardancy test piece. The flame retardancy of the obtained test piece was evaluated in accordance with the UL 94 standard, to thereby obtain results shown in Table 1.

TABLE 1

| | Flame retardancy |
|---|---|
| Example 3 | V0 |
| Example 4 | V0 |
| Example 5 | V0 |
| Example 6 | 5V |
| Comparative Example 1 | V1 |
| Comparative Example 2 | V1 |

As described above, the flame retardancy test confirmed that molded products prepared by molding the resin composition of the present invention had flame retardancy of V0 or 5V.

Further, a casing for a printer or a copier was actually molded with an injection molding machine by using the resin composition of the present invention, and the casing was confirmed to be usable as a product. Assuming recycling of this casing component, the casing was crushed and re-molded, and the re-molded casing was confirmed to be usable as a molded product without problems in flame retardancy and the like.

The present invention is very useful in a broad range of industrial fields employing a molded component formed of a resin such as a plastic and a resin composition such as a sheet-like material, in particular, in applications requiring flame retardancy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-098676, filed Mar. 31, 2006, which is hereby incorporated by reference herein in its entirety.

What is claimed is:

1. A layered silicate compound, which is organophilized with an organophilizing agent having a flame retardant skeleton.

2. A layered silicate compound according to claim 1, wherein the organophilizing agent is a quaternary ammonium compound.

3. A layered silicate compound according to claim 1, wherein the organophilizing agent is a quaternary phosphonium compound.

4. A resin composition comprising a resin and the layered silicate compound according to claim 1.

5. A resin composition according to claim 4, wherein the resin has a furan ring in its molecule.

6. A resin composition according to claim 5, wherein the resin is polyalkylene furan dicarboxylate.

7. A resin composition according to claim 4, containing the layered silicate compound in an amount of 1 mass % or more and 50 mass % or less.

8. A resin composition according to claim 4, wherein the layered silicate compound is dispersed in the resin in a layer-exfoliated state.

9. A method of producing a resin composition comprising: kneading a resin having a furan ring in its molecule and a layered silicate compound organophilized with an organophilizing agent having a flame retardant skeleton; and dispersing the layered silicate compound in the resin.

10. A molded product, which is obtained by molding the resin composition according to claim 4.

11. A method of producing an organophilic layered silicate comprising organophilizing a layered silicate with an organophilizing agent having a flame retardant skeleton.
